(19) United States
(12) Patent Application Publication
(10) Pub. No.: US 2005/0182548 A1
(43) Pub. Date: Aug. 18, 2005

(54) Method and device for detecting parameters characterizing the driving behavior of a vehicle

(75) Inventors: Werner Bernzen, Ehningen (DE); Wilfried Huber, Ostelsheim (DE); Volker Maass, Stuttgart (DE); Avshalom Suissa, Althengstett (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler AG, Stuttgart (DE)

(21) Appl. No.: 10/507,584

(22) PCT Filed: Mar. 7, 2003
(86) PCT No.: PCT/EP03/02341

(30) Foreign Application Priority Data
Mar. 13, 2002 (DE) 102 11 220.7
Mar. 13, 2002 (DE) 102 11 221.5

(51) Int. Cl. G06F 7/70

(52) U.S. Cl. 701/70

(57) ABSTRACT

The invention relates to a method for detecting parameters characterizing the driving behavior of a vehicle, according to which at least one vehicle speed parameter, which represents at least one parameter (ν_{y}) describing the lateral velocity, and/or a roadway parameter describing the quality and/or the course of the roadway is/are detected at least according to one parameter (aₓ) describing the longitudinal acceleration of the vehicle, a parameter (a_{y}) describing the lateral acceleration of the vehicle, a parameter (\dot{ψ}) describing the yaw rate of the vehicle, a parameter (δ, δ_{Rad,i}) characterizing the steering lock of the steered wheels, and parameters (ω_{Rad,i}) describing the rotation speeds of the vehicle wheels by means of an estimation method. A parameter (vₓ) describing ongitudinal velocity of the vehicle is detected as an additional vehicle speed parameter. A parameter (Θ) describing the longitudinal slope of the roadway, and/or a parameter (Φ) describing the transversal slope of the roadway, and/or a parameter (μ) describing the coefficient of friction of the roadway is/are detected as the roadway parameter.

This application claims the priority of German patent documents 102 11220.7 and 102 11 221.5, both filed Mar. 13, 2002 (PCT International Application No. PCT/EP03/02341, filed Mar. 7, 2003), the disclosures of which are expressly incorporated by reference herein.

### BACKGROUND AND SUMMARY OF THE INVENTION

The invention relates to a method and apparatus for determining parameters characterizing the driving behavior of a vehicle.

A wide variety of such methods and devices are known. For example, German patent documents DE 42 26 749 C2 and DE 43 25 413 C2 each disclose a method for determining the attitude angle of a vehicle. According to DE '749, the attitude angle is determined as a function of the longitudinal velocity of the vehicle, its longitudinal acceleration, its lateral acceleration and its yaw rate using state equations. According to DE '413, the attitude angle is determined as a function of the longitudinal velocity of the vehicle, its longitudinal acceleration, its lateral acceleration, its yaw rate, the steering angle, the wheel speeds of the individual wheels and as a state parameter of the angle of inclination of the underlying surface with respect to the flat, using movement equations and at least one measurement equation based on a vehicle model. In comparison with these two methods, the method according to the invention differs in the determination of the input parameters. Furthermore, there is a difference in the structure of the prediction equations and the measurement equations.

German patent document DE 42 00 061 C2 discloses a method for determining the lateral velocity of a vehicle and/or the attitude angle, using a model-supported estimation method. Input parameters taken into account here include not only the steering angle of the vehicle, its longitudinal velocity, and its yaw rate, but also its lateral acceleration of the vehicle and the speeds of the wheels. In an alternative embodiment, the same input parameters are used, with the exception of the lateral acceleration of the vehicle, for which the brake pressures are taken into account. The two methods described in DE '061 differ from the method according to the invention in the input parameters that are used. Furthermore, there are differences in the computing method as well.

In addition, there is no provision to determine an underlying surface parameter in any of these methods.

German patent document DE 196 07 429 A1 describes a control device, with fault tolerance, for a vehicle movement dynamics control device for a motor vehicle. Part of this control device is a state parameter-determining unit, with which state parameter values can be estimated. The latter, which include the attitude angle of the vehicle and the longitudinal velocity of the vehicle, are supplied as input parameters to a vehicle movement dynamics controller. The steering wheel angle, the longitudinal acceleration of the vehicle (on the one hand the lateral acceleration sensed in the front region of the vehicle and on the other hand the lateral acceleration sensed in the rear region of the vehicle), the yaw rate and the wheel speeds are used as input parameters as a function of which the estimation is carried out. The method described in DE '429 differs from the method according to the invention in the output parameters which are obtained by means of estimation, which is inevitably associated with the fact that there are differences in the computing method used.

All of the methods and devices known from the prior art have the disadvantage that they either do not supply the required output parameters which can be determined using the method according to the invention, or, if they can be used to determine the vehicle velocity parameter, these methods do not operate in a continuously reliable fashion in all driving states. That is, there are driving states in which it is not possible to have recourse to the parameters determined by these methods and devices.

One object of the invention, therefore is to provide a method and apparatus for determining vehicle velocity parameters (at least one parameter describing the lateral velocity of the vehicle, and/or underlying surface parameters) which operate in a continuously reliable fashion in all conceivable driving states, so that it is possible to resort to the parameters which are determined in this way in any desired driving states.

This and other objects and advantages are achieved by the method and apparatus according to the invention for determining parameters characterizing the driving behavior of a vehicle, in which at least one vehicle velocity parameter (including at least one parameter describing the lateral velocity of the vehicle and/or an underlying surface parameter which describes the quality and/or course of the underlying surface) is determined using an estimation method. According to the invention, the estimation method takes into account at least a function of a parameter (aₓ) describing the longitudinal acceleration of the vehicle, a parameter (a_{y}) describing the lateral acceleration of the vehicle, a parameter (\dot{ψ}) describing the yaw rate of the vehicle, a parameter (δ, δ_{Rad,i}) characterizing the steering lock of the steered wheels and parameters (ω_{Rad,i}) describing the rotational speeds of the vehicle wheels.

Taking into account the abovementioned parameters ensures that with the method according to the invention it is possible to determine in a continuously reliable fashion, on the one hand, vehicle velocity parameters of which at least one describes the lateral velocity of the vehicle and, on the other hand, underlying surface parameters, in all conceivable vehicle states. This technique thus makes it possible to have recourse to the parameters determined in this way in any driving states.

With the method according to the invention it is possible to determine both the parameter describing the lateral velocity of the vehicle and, as a further vehicle velocity parameter, advantageously also a parameter describing the longitudinal velocity of the vehicle. The parameter describing the longitudinal velocity of the vehicle is required, for example, in slip-based control systems, for determining wheel slip. The parameter describing the lateral velocity of the vehicle is required in control systems with which the lateral dynamics of the vehicle are controlled.

The underlying surface parameter which is determined with the method according to the invention advantageously includes a parameter describing the gradient of the underlying surface, a parameter describing the lateral inclination of the underlying surface and/or a parameter describing the coefficient of friction of the underlying surface. The parameter describing the gradient of the underlying surface is required, for example, to be able to eliminate, from a control process, disruptive influences such as originate from an underlying surface which is inclined in the longitudinal direction of the vehicle. In this regard, it is to be noted that the term gradient of the underlying surface is intended to comprise both a rising and also a falling course of the underlying surface.

The parameter describing the lateral inclination of the underlying surface is also required in order to eliminate, from a control process, disruptive influences which originate from said parameter. By way of example reference is made here to the detection of a steeply walled bend and its consideration during a yaw rate control process. The parameter describing the coefficient of friction of the underlying surface is required, for example, in control systems with which the lateral dynamics of the vehicle are controlled, in order to limit the setpoint value for the yaw rate.

A parameter describing the steering wheel angle, or parameters describing the wheel-specific steering angles set at the steered wheels are advantageously used as the parameters characterizing the steering lock of the steered wheels. It is appropriate to take into account the parameter describing the steering wheel angle since vehicles which are equipped with a control system—corresponding to the series-manufactured state today—for controlling the yaw rate are also equipped with a steering wheel angle sensor. In this case, no additional expenditure would be incurred in terms of the sensor system. However, if the intention of such a control system for controlling the yaw rate is to achieve even higher control accuracy, it is appropriate to use, instead of the individual parameter describing the steering wheel angle, parameters which describe the wheel-specific steering angles set at the steered wheels.

To determine the parameters which describe the wheel-specific steering angle set at the steered wheels, two alternatives are possible. If the expenditure on sensors to be installed in the vehicle is to be kept low, it is appropriate to determine this parameter as a function of the parameter describing the steering wheel angle. However, if these parameters are to be determined very precisely, these should be determined by means of the sensor means assigned to the individual steered wheels.

The estimation method is advantageously model-supported. It is has proven particularly advantageous in this context to use a state observer. The best experience has been with a Kalman filter, because it can be better approximated to the real state by means of the variable gain matrix than other comparable estimation methods.

In addition, a parameter describing the yaw angle acceleration of the vehicle and/or a parameter describing the vertical acceleration of the vehicle are advantageously taken into account during the determination of the vehicle velocity parameter (i.e., at least the parameter describing the lateral velocity of the vehicle and if appropriate the parameter describing the longitudinal velocity of the vehicle and/or the underlying surface parameter). The accuracy of the estimation method is increased by taking yaw angle acceleration into account.

In addition, further individual cases can be sensed and evaluated. The vertical acceleration of the vehicle is required for the determination of the wheel loads which occur at the individual vehicle wheels, and which are in turn required as parameters to be processed in the estimation method.

The parameter describing the longitudinal acceleration of the vehicle, the parameter describing lateral acceleration of the vehicle, and/or the parameter describing vertical acceleration of the vehicle are advantageously pitch-corrected and/or roll-corrected parameters. This ensures elimination of the influence of the movement of the vehicle due to spring compression processes on the parameters to be determined using the estimation method. Carrying out a pitch correction and/or roll correction constitutes, as it were, a transformation starting from a coordinate system which is fixed to the vehicle into a coordinate system which is fixed to the underlying surface. The parameters determined using the estimation method thus includes only influences which are due to the underlying surface.

Pitch correction and/or roll is advantageously corrected as a function of the parameter describing the longitudinal acceleration of the vehicle, the parameter describing the lateral acceleration of the vehicle, and/or the parameter describing the vertical acceleration of the vehicle, using a model (in particular a pitch/roll model). The transformation of the coordinate systems which is mentioned above is carried out using this model.

In one advantageous refinement, the pitch correction and/or roll correction is advantageously carried out as a function of the spring travel which is determined for at least one vehicle wheel. This type of pitch correction and/or roll correction is more precise than that which is mentioned above and is based on a model.

Additionally a parameter describing the pitch angle velocity of the vehicle and/or a parameter describing the roll angle velocity of the vehicle are advantageously taken into account during the determination of the vehicle velocity parameter (i.e., at least the parameter describing the lateral velocity of the vehicle) and, if appropriate, the parameter describing the longitudinal velocity of the vehicle and/or the underlying surface parameter. The accuracy of the estimation method used is increased by taking into account the change in the pitch angle over time and the change in the roll angle over time since the chronological and thus dynamic behavior is also taken into account in addition to the quasi-steady-state situation described by the values of the pitch angle and of the roll angle.

The parameters describing the pitch angle velocity and/or the roll angle velocity of the vehicle are advantageously corrected as a function of the spring travel determined for at least one vehicle wheel, by the component of the pitching movement and/or rolling movement of the vehicle in relation to the road. In one alternative embodiment, the parameter describing the pitch angle velocity of the vehicle and/or the parameter describing the roll angle velocity of the vehicle are corrected using a pitch/roll model by the component of the pitching movement and/or rolling movement of the vehicle in relation to the road. These two alternative measures also lead to an increase in the accuracy of the estimation method used, this is because they also ensure elimination of the influence of the movement of the vehicle itself due to spring compression processes on the parameters to be determined using the estimation.

A parameter describing the pitch angle acceleration of the vehicle and/or the roll angle acceleration of the vehicle is advantageously determined using the parameter describing the vertical acceleration of the vehicle, for more than one point of the vehicle; and the parameter describing the pitch angle velocity of the vehicle is determined as a function of the parameter describing the pitch angle acceleration, and/or the parameter describing the roll angle velocity of the vehicle is determined as a function of the roll angle acceleration. By determining the pitch angle velocity and/or the roll angle velocity as a function of the parameter describing the vertical acceleration of the vehicle it is possible to dispense with special sensor means which are rotational speed sensors correspondingly arranged in the vehicle.

The method according to the invention supplies reliable estimated values for the parameters comprising the longitudinal velocity, lateral velocity, gradient or slope of the underlying surface and lateral inclination of the underlying surface in all conceivable driving states and under all conceivable ambient conditions, even when underlying surfaces are inclined laterally and longitudinally and have different coefficients of friction.

Furthermore, the method according to the invention supplies a reliable estimated value for the average coefficient of friction of the underlying surface if the longitudinal slip/lateral slip of at least one wheel of the vehicle is in the vicinity of the adhesion limit.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of the driving state observer on which the method according to the invention is based, with the input parameters supplied to it and the output parameters which are output by it; and

FIG. 2 is a schematic view of the specific implementation of the driving state observer as a Kalman filter.

### DETAILED DESCRIPTION OF THE DRAWINGS

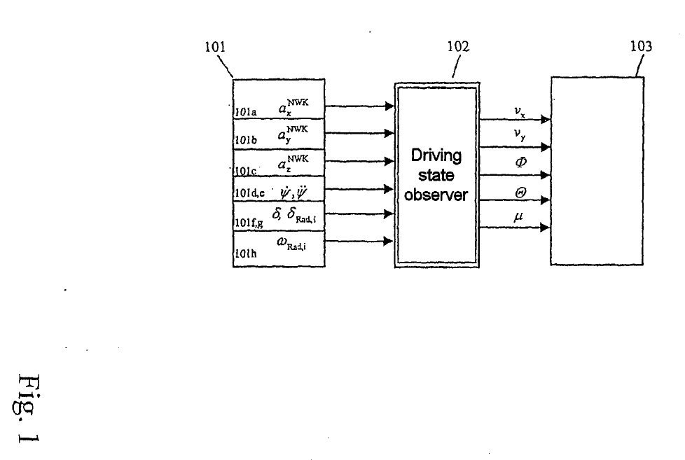

In FIG. 1, the driving state observer 102 which forms the basis of the method according to the invention (and which is, formulated in general terms, a computer), is illustrated with the input parameters supplied to it and the output parameters which it provides. The input parameters are supplied to the driving state observer 102 from a block 101 which consists of various sensor means that can generally be referred to as sensing means. The output parameters which are determined by the driving state observer 102 are supplied to various processing means, which are arranged in the vehicle and combined to form a block 103, for further processing.

As is apparent from the illustration in FIG. 1, the following parameters can be supplied as input parameters to the driving state observer 102:
A pitch-corrected and/or roll-corrected longitudinal acceleration parameter aₓ^{NWK}, which is made available by a sensor means 101a with which a parameter describing the longitudinal acceleration of the vehicle is sensed and a corresponding pitch correction and/or roll correction is carried out. Alternatively, the parameter ax describing the longitudinal acceleration of the vehicle can also be supplied directly, i.e. without pitch correction and/or roll correction having been performed. In this case, the block 101a is then a conventional longitudinal acceleration sensor. The pitch correction and/or roll correction which is possibly necessary is then performed in the block 102.
A pitch-corrected and/or roll-corrected lateral acceleration parameter a_{y}^{NWK}, which is provided by a sensor means 101b with which a parameter describing the lateral acceleration of the vehicle is sensed and a corresponding pitch correction and/or roll correction is carried out. Alternatively, the parameter ay describing the lateral acceleration of the vehicle can also be supplied to the driving state observer 102 directly (i.e., without pitch and/or roll correction). In this case, the block 101b is a conventional lateral acceleration sensor. Any pitch correction and/or roll correction which may be necessary is then performed in the block 102.
A pitch-corrected and/or roll-corrected vertical acceleration parameter a_{z}^{NWK}, which is provided by a sensor means 101c with which a parameter describing the vertical acceleration of the vehicle is sensed and a corresponding pitch correction and/or roll correction is carried out. Alternatively, the parameter az describing the vertical acceleration of the vehicle can also be supplied to the driving state observer 102 directly (i.e., without pitch correction and/or roll correction). In this case, the block 101c is then a conventional vertical acceleration sensor. Any pitch correction and/or roll correction which may be necessary is then performed in the block 102.
A parameter \dot{ψ} which describes the yaw rate of the vehicle and which is sensed using a yaw rate sensor 101d which is known from the prior art.

A parameter \ddot{Ψ} which describes the yaw angle acceleration of the vehicle and which is sensed either using a suitable sensor means 101e or which is derived computationally from the parameter \dot{ψ} describing the yaw rate of the vehicle.
A parameter characterizing the steering lock of the steered wheels. This can be, for example, a parameter δ which describes the steering wheel angle and which is sensed using a steering angle sensor 101f which is known from the prior art. Alternatively, the parameters may be parameters δ_{Rad,i} which describe the wheel-specific steering angles set at the steered wheels. These parameters may either be derived from the parameter δ or they are sensed by means of sensor means 101g which are assigned to the individual steered wheels and which are angle pickups known from the prior art. At this point it is to be noted that the exemplary embodiment is based on a vehicle which is equipped with front axle steering. This is not intended to constitute a restriction. The vehicle can also have a rear axle steering system in addition to the front axle steering system.
Parameters ω_{Rad,i} describing the rotational speeds of the vehicle wheels. Said parameters are sensed using wheel speed sensors 101h known from the prior art.

The combination of the various sensor means specified above which is carried out in FIG. 1 to form a block 101 is not intended to have a restrictive effect. Of course, all the sensor means which are specified above can be arranged physically separately in the vehicle. Alternatively it is appropriate to combine at least some of the sensor means specified above to form one physical unit, referred to as a sensor module. For example, the lateral acceleration sensor, the longitudinal acceleration sensor, the vertical acceleration sensor and the yaw rate sensor can be combined to form such a sensor module. The sensor for sensing the yaw angle acceleration is possibly also contained in such a sensor module. The remaining sensor means which are specified in the listing above are then installed independently in the vehicle.

At this point it is to be noted that the driving state observer 102 does not require all the input parameters represented in FIG. 1 in order to determine the output parameters represented in said figure. Essentially the following parameters are sufficient: the longitudinal acceleration of the vehicle, lateral acceleration of the vehicle, yaw rate, rotational speeds of the vehicle wheels and (depending on the equipment level of the vehicle), steering wheel angle or wheel-specific steering angles for at least two vehicle wheels (particularly, the front wheels of the vehicle). The two acceleration parameters can already be supplied to the driving state observer here in a pitch-corrected and/or roll-corrected form. Alternatively, the pitch correction and/or roll correction can be performed in the actual driving state observer.

As is apparent from the illustration in FIG. 1, the driving state observer determines the following output parameters which are supplied to the processing means 103:
a parameter υy describing the lateral velocity of the vehicle and/or
a parameter υx describing the longitudinal velocity of the vehicle and/or
a parameter Φ describing the lateral inclination of the underlying surface and/or
a parameter Θ describing the gradient of the underlying surface and/or
a parameter μ describing the coefficient of friction of the underlying surface.

These output parameters can be divided into two groups: vehicle movement parameters which describe the movement of the vehicle (more precisely, vehicle velocity parameters), and underlying surface parameters which describe the quality and/or course of the underlying surface.

In a specific case, the vehicle velocity parameters are the parameter describing the lateral velocity of the vehicle and the parameter describing the longitudinal velocity of the vehicle. The underlying surface parameters are those describing the gradient or lateral inclination of the underlying surface and the parameter describing the coefficient of friction of the underlying surface.

The processing means which are combined in FIG. 1 to form the block 103 may be, in general terms, devices with which a parameter describing and/or influencing the movement of the vehicle is regulated and/or controlled. In a specific case, these may be the following processing means:
a yaw rate controller with which the yaw rate of the vehicle (i.e., the rotational movement of the vehicle about its vertical axis) is controlled;
a brake slip controller;
a traction controller;
a device which is used to influence the damping behavior and/or suspension behavior of the chassis;
an inter-vehicle controller in which the distance from the vehicle traveling in front is set using interventions into the brakes or into the engine;
an engine controller; and/or
a transmission controller.

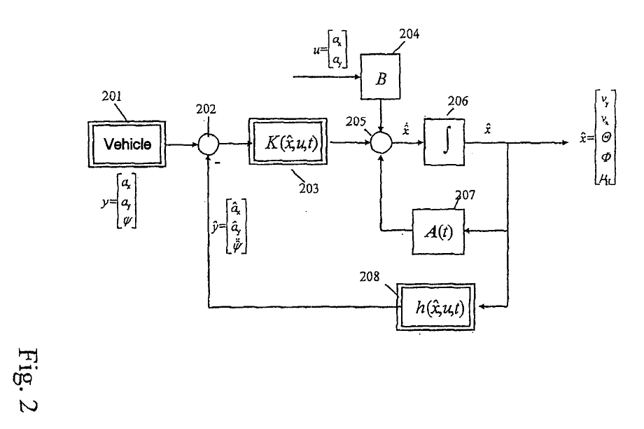

The specific implementation of the driving state observer 102 is illustrated in FIG. 2.

The method according to the invention is based on a state observer which is embodied as a Kalman filter and which has the structure illustrated in FIG. 2.

Using such a Kalman filter it is possible to estimate a multi-dimensional state which is represented in the present exemplary embodiment by the vector x, of a system which is described in a general form by the prediction equations represented in vector form as
\dot{x}=Ax+Bu+w(t) (1)
using measurement equations of the general form
y=h(x,u)+v(t) (2)

These two vector equations (1) and (2) which are formulated in a chronologically continuous form constitute the general approach of the Kalman filter which forms the basis of the exemplary embodiment.

From two equations (1) and (2) it is possible to derive the equation system represented in vector form
\hat{\dot{x}}=A\hat{x}+Bu+K[y−h(\hat{x},u)] (3)
K=PC^{T}R⁻¹ (4)
\dot{P}=FP+PF^{T}−PC^{T}R⁻¹CP+Q′ (5)
which describes the Kalman filter illustrated in FIG. 2 and which represents the filter equations.

The individual terms which are used in the equations (1) to (5) have the following meaning:
The vector x contains the individual physical parameters which represent the state of the system to be estimated. These physical parameters are designated as state parameters. Accordingly, the vector \hat{x} contains the estimated values which are determined for these physical parameters. The physical parameters are the parameter νx describing the longitudinal velocity of the vehicle, the parameter νy describing the lateral velocity of the vehicle, the parameter Φ describing the lateral inclination of the underlying surface, the parameter Θ describing the gradient of the underlying surface and the parameter μ describing the coefficient of friction of the underlying surface.

The vectors u and y each contain some of the parameters which are supplied to the Kalman filter as input parameters. The vector u contains the parameter ax describing the longitudinal acceleration of the vehicle, and the parameter ay describing the lateral acceleration of the vehicle. The vector y also contains the parameter ax describing the longitudinal acceleration of the vehicle and the parameter ay describing the lateral acceleration of the vehicle and in addition the parameter \dot{Ψ} describing the yaw angle acceleration of the vehicle.
The individual elements of the two matrices A and B result from the prediction equations considered.
The individual elements of the matrix h(\hat{x}, u) result from the measurement equations considered.
The term w(t) represents the system noise which is present.
The term v(t) represents measuring noise which is present.
The two matrices F and C are Jacobi matrices.
The two matrices Q and R are the power density matrices of the respective noise.
The matrix P corresponds to the covariance matrix.

The equations and equation systems (1) to (5) above are formulated in a chronologically continuous fashion. At least the equations (3) to (5) have to be represented discretely over time in order to implement the Kalman filter. This representation which is discrete over time is not given, for the sake of clarity and since it constitutes a reformulation which is familiar to a person skilled in the art.

The system for which states are to be estimated is a motor vehicle in the present exemplary embodiment.

The following prediction equations are used as the basis of a first embodiment of the Kalman filter:
ν_{y}=−\dot{ψ}νₓ−gΦ+a_{y}^{NWK} (6)
νₓ=\dot{ψ}ν_{y}+gΘ+aₓ^{NWK} (7)=
\dot{Φ}=0 (8)
\dot{Θ}=0 (9)
\dot{μ}a(t)μ+b(t) (10)

The equations (6) to (10) represent the individual equations of the equation system (1), the measuring noise not being taken into account in the representation of the equations (6) to (10). The left-hand terms of equations (6) to (10) represent the changes over time of the state variables to be estimated. The values of the state variables in turn result from the changes over time due to integration. The state parameters correspond to the output parameters contained in FIG. 1. In particular, these parameters are the longitudinal velocity νx of the vehicle, the lateral velocity νy of the vehicle, the lateral inclination Φ of the underlying surface, the slope Θ of the underlying surface and the average coefficient of friction μ of the underlying surface. The individual elements of the two matrices A and B are determined from the right-hand terms of the equations (6) to (10). The equations (6) to (10) represent state equations with which the movement of the vehicle can be described.

Equation (10) represents the prediction equation for the coefficient of friction of the underlying surface, to be more precise for the average coefficient of friction of the underlying surface. The constant values 0.995 and 0.005 can be selected, for example, for the two terms a(t) and b(t). When a steeply walled bend is present, the value 0.01 can be selected for the term b(t) instead of the value 0.005, permitting the coefficient of friction to be followed more closely. The term a(t) can also be formulated as a function of the vertical acceleration of the vehicle.

As already mentioned with respect to the consideration of the advantages of the method according to the invention, the method according to the invention provides a reliable estimated value for the average coefficient of friction of the underlying surface if the longitudinal slip/lateral slip of at least one wheel of the vehicle is in the vicinity of the adhesion limit. The reason for this is as follows: equation (10) is the prediction equation for estimating the coefficient of friction of the underlying surface. The maximum possible coefficient of friction of the underlying surface (i.e., the value 1), is usually selected as the starting value of the estimation. This starting value is included in the summands a(t)μ. If the situation described above in which a wheel of the vehicle is in the vicinity of the adhesion limit is present, a first approximate item of information about the coefficient of friction of the underlying surface is already available in this situation. This value, which at any rate describes the situation better than the value assumed as being 1, can then be used as a starting value. As a result, the Kalman filter can determine more quickly the precise value of the coefficient of friction of the underlying surface which is present in this situation.

For the measurement equation (2) which is generally formulated in a vectorial form, the following equations are used in the exemplary embodiment:

$$\begin{matrix}{a}_{y}^{NWK} = \frac{1}{m} \sum {F}_{y} \\ = {a}_{y}^{Modell} ( {v}_{y} , {v}_{x} , {a}_{z}^{NWK} , \dot{ψ} , {δ}_{Rad , i} , μ , {ω}_{Rad , i} ) & ( 11 ) \\ {a}_{x}^{NWK} = \frac{1}{m} \sum {F}_{x} \\ = {a}_{x}^{Modell} ( {v}_{y} , {v}_{x} , {a}_{z}^{NWK} , \dot{ψ} , {δ}_{Rad , i} , μ , {ω}_{Rad , i} ) & ( 12 ) \\ \ddot{ψ} = \frac{1}{{J}_{z}} \sum {M}_{z} \\ = {\ddot{ψ}}^{Modell} ( {v}_{y} , {v}_{x} , {a}_{z}^{NWK} , \dot{ψ} , {δ}_{Rad , i} , μ , {ω}_{Rad , i} ) & ( 13 )\end{matrix}$$

The Kalman filter is adapted to the real conditions during its operation using these measurement equations. The adaptation is carried out by comparing measured parameters with parameters which are determined using various models. In other words: the Kalman filter is supported by a comparison with reality.

In the above three measurement equations (11), (12) and (13), the expressions to the left of the first equals sign represent the measured parameters. That is, a value is measured for the lateral acceleration of the vehicle, for the longitudinal acceleration of the vehicle and the yaw angle acceleration. In the case of the lateral acceleration of the vehicle and the longitudinal acceleration of the vehicle these parameters are subject to a pitch correction and/or roll correction.

In the above three measurement equations (11), (12) and (13), the terms which appear between the two equals signs indicate that the measured parameters can also be calculated. In the case of the lateral acceleration of the vehicle, the calculation can be carried out as a function of the side forces acting on the vehicle, and in the case of the longitudinal acceleration of the vehicle they can be carried out as a function of the longitudinal forces acting on the vehicle. In the case of the yaw angle acceleration, the calculation can be carried out as a function of the torques acting on the vehicle, about its vertical axis.

The terms appearing to the right next to the second equals signs show which parameters are used as a basis for determining the model variables for the lateral acceleration of the vehicle, the longitudinal acceleration of the vehicle and the yaw angle acceleration. The model-supported determination is carried out as a function of the lateral velocity of the vehicle, the longitudinal velocity of the vehicle, the pitch-corrected and/or roll-corrected vertical acceleration of the vehicle, the yaw rate, the parameter characterizing the steering lock of the steered wheels, the parameter describing the coefficient of friction of the underlying surface and the parameters describing the rotational speeds of the vehicle. The three models are each based on a two-lane vehicle model and a non-linear tire model (that is, a non-linear tire characteristic). Furthermore, the wheel loads are determined on the basis of the vertical acceleration of the vehicle.

Of the three measurement equations (11), (12) and (13) above, the first two are taken into consideration in all cases. The third measurement equation is considered only if the yaw angle acceleration of the vehicle is to be evaluated in addition to the lateral acceleration and the longitudinal acceleration of the vehicle.

From the measurement equations (11), (12) and (13) it is apparent that all the input parameters represented in FIG. 1, and of the output parameters illustrated in FIG. 1 at least the longitudinal velocity of the vehicle, the lateral velocity of the vehicle and the coefficient of friction of the underlying surface, are included in the adaptation of the Kalman filter. Taking into account the output parameters when adapting the Kalman filter makes the method into a recursive estimation method.

If the pitch correction and/or roll correction which has already been mentioned repeatedly is performed using a model, the following model has proven particularly advantageous:

$$\begin{matrix}[ \begin{matrix}{a}_{x}^{NWK} \\ {a}_{y}^{NWK} \\ {a}_{z}^{NWK}\end{matrix} ] = [ \begin{matrix}1 & 0 & Θ \\ 0 & 1 & - Φ \\ - Θ & Φ & 1\end{matrix} ] [ \begin{matrix}{a}_{x}^{Sensor} \\ {a}_{y}^{Sensor} \\ {a}_{z}^{Sensor}\end{matrix} ] & ( 14 ) \\ where & \\ Θ = - {e}_{Θ} {a}_{x}^{NWK} & ( 15 ) \\ Φ = {e}_{Φ} {a}_{y}^{NWK} & ( 16 ) \\ Θ = \frac{- {e}_{Θ} {a}_{x}^{Sensor}}{1 + {e}_{Θ} {a}_{z}^{Sensor}} & ( 17 ) \\ Φ = \frac{{e}_{Φ} {a}_{y}^{Sensor}}{1 + {e}_{Φ} {a}_{z}^{Sensor}} . & ( 18 )\end{matrix}$$

Using this model, a transformation is performed on the basis of a coordinate system which is fixed with respect to the vehicle into a coordinate system which is fixed with respect to the underlying surface. That is, the parameters comprising the longitudinal acceleration, lateral acceleration and/or vertical acceleration which are determined using the sensors mounted in the vehicle are transformed into corresponding parameters which are fixed with respect to the underlying surface.

As an alternative to the first embodiment of the Kalman filter it is possible to use the following, second embodiment. This second embodiment is based on expanded prediction equations. These expanded prediction equations are:
\dot{ν}_{y}=−\dot{ψ}νₓ−gΦ+a_{y}^{NWK} (6′)
\dot{ν}_{x-\dot{ψ}ν}_{y}gΘ+aₓ^{NWK} (7′)
\dot{Φ}=ωₓ^{NWK} (8′)
\dot{Θ}=ω_{y}^{NWK} (9′)
\dot{μ}a(t)μ+b(t) (10′)

A comparison of the set of prediction equations of the first embodiment with that of the second embodiment shows that the first, second and fifth prediction equations are identical. The two approaches differ only in the third and fourth equations. By taking into account the pitching movement (equation (8′)) and the rolling movement (equation (9′)), the Kalman filter according to the second embodiment has the advantage that changes in the longitudinal inclination of the underlying surface and/or in the lateral inclination of the underlying surface are sensed more quickly than in the case of the Kalman filter according to the first embodiment. However, additional sensors are necessary for this purpose. The vehicle must also be equipped with sensor means for sensing the rolling movement and the pitching movement.

Details on the representation in FIG. 2 will be given below. It is to be noted in advance here that in FIG. 2 the acceleration parameters are not illustrated as pitch-corrected and/or roll-corrected parameters. In this case, the necessary pitch correction and/or roll correction is performed outside the Kalman filter.

The right-hand term of equation (3) is present at the output of the sum former 205, i.e., the chronological changes of the state parameters are present at this output. Using the integrator 206, the current values of the state parameters are determined on the basis of these current chronological changes of the state parameters and on the basis of the values of the state parameters from preceding time steps. These current values of the state parameters are output in the form of the vector \hat{x}. These current values of the state parameters are fed back. For this purpose, the vector \hat{x} is supplied to the two blocks 207 and 208. In the block 207, the term A\hat{x} of the right-hand side of the equation (3) is formed. In the block 208, the model-supported values are determined for the lateral acceleration, the longitudinal acceleration and, if this parameter is taken into account, also for the yaw angle acceleration. In other words: in the block 208, the terms of the measurement equations (11), (12) and (13) which are positioned to the right of the second equals signs are determined. In the block 208, the supporting parameters for the adaptation of the Kalman filter (i.e., the estimated values for the measured parameters comprising the longitudinal acceleration of the vehicle) lateral acceleration of the vehicle and yaw angle acceleration are determined. These are supplied to a difference former 202.

Block 201 constitutes part of the sensor system arranged in the vehicle. Measured values for the longitudinal acceleration of the vehicle, the lateral acceleration of the vehicle and the yaw angle acceleration are determined with this sensor system. These measured values represent the terms which are positioned to the left of the first equals signs of the measurement equations. These measured values are also supplied to the difference former 202. In the difference former, the difference between the measured values and the estimated values is formed in order to carry out the adaptation of the Kalman filter. This difference corresponds to the term contained in the square brackets of the equation (3). This difference is supplied to a block 203 in which the variable gain of the Kalman filter is determined. The block 203 generates the term K[y−h(ĉ, u)] of the equation (3) as output parameter. This is supplied to the sum former 205. The sum former 205 is also supplied with an output parameter which is determined in block 204 and which corresponds to the term Bu of the equation (3).

In conclusion, the mode of operation of the method according to the invention will be described once more in a generalized form. All the input parameters which are conceivable according to the exemplary embodiment are taken into account:

Using the method according to the invention it is possible to determine vehicle velocity parameters (i.e., at least one parameter describing the lateral velocity of the vehicle and, if appropriate, one parameter describing the longitudinal velocity of the vehicle, and/or underlying surface parameters which describe the quality and/or course of the underlying surface), using an estimation method at least as a function of parameters describing the vehicle's longitudinal acceleration, lateral acceleration, vertical acceleration of, yaw rate, yaw angle acceleration, rotational wheel speeds, and/or, depending on how the vehicle is equipped, either the steering wheel angle or wheel-specific steering angles for at least two vehicle wheels (in particular the front wheels of the vehicle). If the vehicle is also equipped with a rear-axle steering system, all the wheel steering angles can be taken into account as input parameters.

In the sense of the exemplary embodiment, both the vehicle velocity parameters and the underlying surface parameters constitute parameters characterizing the driving behavior.

To summarize, the mode of operation of the Kalman filter can be represented as follows:

Using the Kalman filter, the current chronological changes are determined for the state parameters in relation to the current time step (block 205). Current values for the state parameters are determined from these current chronological changes and the values of the state parameters of preceding time steps by means of integration (block 206). Using mathematical models, estimated values are determined for at least some of the measured parameters as a function of the current values of the state parameters (block 208). Using the difference (block 202) between the values measured for the measured parameters and the estimated values, an adaptation of the Kalman filter is carried out (block 203) in which the variable gain of the Kalman filter is adapted to the conditions in reality. This adaptation of the variable gain gives rise to a correction in the determination of the chronological changes of the state parameters and thus to a correction during the determination of the values of the state parameters of the subsequent time step.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-17. (canceled)

18. A method for determining parameters characterizing driving behavior of a vehicle, with which at least one of a vehicle velocity parameter, being at least one parameter (ν_{y}) describing the lateral velocity of the vehicle and an underlying surface parameter which describes at least one of the quality and the course of the underlying surface, is determined using an estimation method, at least as a function of parameters (aₓ) describing the longitudinal acceleration of the vehicle, (a_{y}) describing the lateral acceleration of the vehicle, (\dot{ψ}) describing the yaw rate of the vehicle, (δ, δ_{Rad,i}) characterizing the steering lock of the steered wheels, and (ω_{Rad,i}) describing the rotational speeds of the vehicle wheels, wherein:
in addition, a parameter (a_{z}) describing vertical acceleration of the vehicle is taken into account in determining at least one of the vehicle velocity parameter and the underlying surface parameter;
the at least one of parameters (aₓ) describing the longitudinal acceleration of the vehicle, (a_{y}) describing the lateral acceleration of the vehicle, and (a_{z}) describing the vertical acceleration of the vehicle are pitch-corrected or roll-corrected parameters (aₓ^{NWK}, a_{y}^{NWK}, a_{z}^{NWK});
the pitch or roll correction is carried out as a function of at least one of the parameters (aₓ) describing the longitudinal acceleration of the vehicle of the parameter (a_{y}) describing the lateral acceleration of the vehicle, and (a_{z}) describing the vertical acceleration of the vehicle, using a pitch/roll model.

19. The method as claimed in claim 18, wherein a parameter (νₓ) describing the longitudinal velocity of the vehicle is determined as a further vehicle velocity parameter.

20. The method as claimed in claim 18, wherein at least one of a parameter (Θ) describing a gradient of the underlying surface, a parameter (Φ) describing lateral inclination of the underlying surface and a parameter (μ) describing the coefficient of friction of the underlying surface is determined as an underlying surface parameter.

21. The method as claimed in claim 18, wherein one of a parameter (δ) describing a steering wheel angle and parameters (δ_{Rad,i}) describing the wheel-specific steering angles set at the steered wheels is used as a parameter (δ, δ_{Rad,i}) characterizing steering lock of the steered wheels.

22. The method as claimed in claim 21, wherein the parameters (δ_{Rad,i}) describing the wheel-specific steering angle set at the steered wheels are determined by one of a function of the parameter (δ) describing the steering wheel angle and by means of sensor means assigned to the individual steered wheels.

23. The method as claimed in claim 18, wherein the estimation method is a model supported estimation method.

24. The method as claimed in claim 18, wherein the estimation method is based on a state observer, in particular on a Kalman filter.

25. The method as claimed in claim 18, wherein in addition a parameter (\ddot{Ψ}) describing the yaw angle acceleration of the vehicle is taken into account in determining at least one of the vehicle velocity parameter and the underlying surface parameter.

26. The method as claimed in claim 18, wherein at least one of the pitch correction and roll correction is carried out as a function of the spring travel determined for at least one vehicle wheel.

27. The method as claimed in claim 18, wherein at least one of a parameter (ωₓ) describing the pitch angle velocity of the vehicle and a parameter (ω_{y}) describing the roll angle velocity of the vehicle is taken into account in determining at least one of the vehicle velocity parameter and the underlying surface parameter.

28. The method as claimed in claim 27, where at least one of the parameters (ωₓ) describing the pitch angle velocity of the vehicle and (ω_{y}) describing the roll angle velocity of the vehicle is corrected as a function of spring travel determined for at least one vehicle wheel, by a component of at least one of the pitching and rolling movement of the vehicle relative to the road.

29. The method as claimed in claim 27, wherein at least one of the parameters (ωₓ) describing the pitch angle velocity of the vehicle and the parameter (ω_{y}) describing the roll angle velocity of the vehicle is corrected using a pitch/roll model, by a component of at least one of pitching movement and rolling movement of the vehicle in relation to the road.

30. The method as claimed in claim 27, wherein:
at least one of a parameter (\dot{ω}ₓ) describing the pitch angle acceleration of the vehicle and a parameter (\dot{ω}_{y}) describing the roll angle acceleration of the vehicle is determined using the parameter (a_{z}) describing the vertical acceleration of the vehicle, for more than one point of the vehicle; and at least one of the following is true,
the parameter (ωₓ) describing the pitch angle velocity of the vehicle is determined as a function of the parameter (\dot{ω}ₓ) describing the pitch angle acceleration, and
the parameter (ω_{y}) describing the roll angle velocity of the vehicle is determined as a function of the parameter (\dot{ω}_{y}) describing the roll angle acceleration.

31. A device for determining parameters characterizing the driving behavior of a vehicle, said device comprising sensing means for sensing at least one of a parameter (aₓ) describing the longitudinal acceleration of the vehicle, a parameter (a_{y}) describing the lateral acceleration of the vehicle, a parameter (\dot{ψ}) describing the yaw rate of the vehicle, a parameter (δ, δ_{Rad,i}) characterizing the steering lock of the steered wheels and parameters (ω_{Rad,i}) describing the rotational speeds of the vehicle wheels, and computing means for determining at least one of a vehicle velocity parameter, being at least one parameter (ν_{y}) describing the lateral velocity of the vehicle, and an underlying surface parameter which describes at least one of the quality and course of the underlying surface, using an estimation method, at least as a function of the parameter (aₓ) describing the longitudinal acceleration of the vehicle, the parameter (a_{y}) describing the lateral acceleration of the vehicle, the parameter (\dot{ψ}) describing the yaw rate of the vehicle, the parameter (δ, δ_{Rad,i}) characterizing the steering lock of the steered wheels and the parameters (ω_{Rad,i}) describing the rotational speeds of the vehicle wheels, wherein:
in addition, a parameter (a_{z}) describing vertical acceleration of the vehicle is sensed with the sensing means, and is taken into account in determining at least one of the vehicle velocity parameter and/or the underlying surface parameter;
at least one of the parameter (aₓ) describing the longitudinal acceleration of the vehicle, the parameter (a_{y}) describing the lateral acceleration of the vehicle and the parameter (a_{z}) describing the vertical acceleration of the vehicle comprises at least one of pitch-corrected and roll-corrected parameters (aₓ^{NWK}, a_{y}^{NWK}, a_{z}^{NWK}); and
at least one of pitch correction and roll correction is carried out as a function of at least one of the parameter (aₓ) describing the longitudinal acceleration of the vehicle, the parameter (a_{y}) describing the lateral acceleration of the vehicle and the parameter (a_{z}) describing the vertical acceleration of the vehicle, using a pitch/roll model.

32. The device as claimed in claim 31, wherein a parameter (υₓ) describing the longitudinal velocity of the vehicle is determined as a further vehicle velocity parameter.

33. The device as claimed in claim 31, wherein at least one of the following is true:
at least one of pitch correction and roll correction for the parameter (aₓ) describing the longitudinal acceleration of the vehicle is carried out in a sensor means contained in the sensing means;
at least one of pitch correction and roll correction for the parameter (a_{y}) describing the lateral acceleration of the vehicle is carried out in a sensor means contained in the sensing means: and
at least one of pitch correction and roll correction for the parameter (a_{z}) describing the vertical acceleration of the vehicle is carried out in a sensor means contained in the sensing means.

34. The device as claimed in claim 31, wherein at least one of the pitch correction and/or roll correction is carried out in the computing means.
